(19) United States
(12) Patent Application Publication
(10) Pub. No.: US 2007/0016721 A1
(43) Pub. Date: Jan. 18, 2007

(54) Flash file system power-up by using sequential sector allocation

(75) Inventor: Bill Gay, Santa Clara, CA (US)

Correspondence Address: MCDERMOTT WILL & EMERY LLP, 18191 VON KARMAN AVE., SUITE 500, IRVINE, CA, 92612-7108, US

(73) Assignee: Wyse Technology Inc.

(21) Appl. No.: 11/182,759

(22) Filed: Jul. 18, 2005

(51) Int. Cl. G06F 12/00

(52) U.S. Cl. 711/103; 711/170

(57) ABSTRACT

A method and system for reducing the time for initializing a non-volatile memory device, such as flash memory, at power-up that takes advantage of the fact that many file systems are designed to perform sequential writes within a block of data units. The method and system includes, in one aspect, reading the last page of a block, determining the logical sector number of the page and generating a mapping table for that block by allocating the logical sector number to the last page and respectively allocating to each remaining page sequentially decreasing logical sector numbers. When not all sectors in the block are consecutive, mapping table information is built by reading only one page from each chain of consecutive sectors. In another aspect, a “deleted sector(s) present” flag is used in the last page of each block to determine whether the block contains deleted sectors, in which case the initialization procedure generally reads all sectors in the block. In addition, the initialization procedure reduces the time required to identify erased blocks by reading only the first and last pages of the block.

### BACKGROUND

### Background of the Invention

1. Field of the Invention

The present invention relates generally to flash and non-volatile memory, and more specifically to increasing file system efficiency for flash memory devices.

2. Description of Related Art

Flash memory is a type of non-volatile memory that is commonly used in a wide variety of processing devices such as computer systems, computer terminals, cameras, handheld devices, music and video players, game consoles, and other electronic systems. Flash memory is a solid state form of memory that is used for the fast, easy and compact storage of data. Examples of flash memory may include, for example, the BIOS chip of a computer, CompactFlash™ and SmartMedia™ memory cards, PCMCIA flash memory cards used in notebook computers, and the like.

Flash memory may be controlled by a file system of a processing device via a software layer known as the flash translation layer. The flash translation layer may include a series of routines that emulates a sector-addressable device for the file system to enable the file system to access and store data on storage units within the flash memory device. The file system driver manages the file system of the processing device in which the flash device is used, which may be a computer, dumb terminal, PDA, etc. For example, in a windows environment, a computer terminal may implement an operating system which uses a FAT or NTFS file system. Where the computer terminal or other device includes flash memory and the processor performs reads or writes to the flash memory, the flash translation layer ordinarily receives the read/write requests from the file system driver. Thereupon, the flash translation layer accesses the flash hardware directly, applying an appropriate mapping. Other methods for accessing the flash hardware may be suitable depending on the processing device and applications involved.

In many configurations, flash memory contains sectors, or read/write units referenced by the file system driver for data storage or access. A plurality of sectors may correspond to one or more pages using a mapping scheme. A group of pages may form a memory block. Memory mapping is ordinarily used to translate logical addresses from the file system into physical addresses associated with the flash device. In one implementation, memory mapping is performed at the sector level, so that each logical sector referenced by the file system driver corresponds to a physical page on the flash device. The logical sector number of each page may be stored in the redundant area, which represents a dedicated portion of each sector, outside of the normal data area, for storing certain relevant information about the page, the block containing the page, or the flash device. A mapping table for the entire device may be stored in another memory or storage mechanism used by the underlying device, such as in the random access memory in the case of a personal computer. Ordinarily indexed by a logical sector number, entries in the mapping table contain the page corresponding to the logical sector. The flash translation layer may in some implementations read the redundant area of each page to acquire the logical sector numbers and build the mapping table when the system powers up.

Nand flash file systems generally use a similar mapping of logical units to physical units. Among other features, this mapping allows the flash translation layer to move around data from one block to another for wear-leveling purposes. In particular, it may be undesirable to use the same memory blocks over and over while other blocks remain substantially unused over time. The chronically-used memory blocks may eventually sustain sufficient wear to corrupt the device, a problem which could have been avoided by a broader distribution of the allocation of memory blocks, thereby increasing the life span of the flash device. Wear-leveling techniques accomplish this purpose by randomizing the allocation of new blocks for data storage, and by actively swapping out data from blocks which are updated infrequently.

Flash memory provides great advantages in, among other features, its durability, small size, solid state nature, and its capability to retain data on power off. The use of flash memory, however, is not without its disadvantages. First, the flash memory generally must be initialized upon power-up of the processing device. Each sector's mapping information is typically stored in a redundant area of that sector. Using a redundant area associated with each sector allows the mapping information to be written at the time the sector is written.

A problem that has persisted in the art is the difficulty for file systems to access each sector and create a mapping table in a timely fashion. As noted above, a mapping table may be stored in the volatile memory of a device (e.g., RAM). The process of accessing each redundant area of every sector on a flash device to generate a mapping table may cause highly undesirable slowdowns in the power-up sequence of the device as the file system proceeds to scan every sector. In one illustration, and depending on the configuration, it may take up to or greater than 25 microseconds for a file system to address each sector in order to create the necessary mapping between physical and logical addresses. Such a technique at start up can create unacceptable delays in the power-up of the computer or other underlying device.

A further problem relates to the size of the mapping table. The more information the file system must collect from the flash device, generally the more complex the mapping information. This complexity results in the requirement of more storage space in memory. Accessing each sector of a flash device can produce an undesirably large and complex mapping table, reducing memory availability for other applications.

Various techniques to help address these problems have been proposed in the literature. For example, one method attempts to speed up performance at power-up by consolidating all of the mapping information in a file while the device is running. The file can then be summarily accessed upon power-up, thereby removing certain steps in the initialization process. A major shortcoming with this procedure is that the mapping file must be written or updated every time the system is powered down. This method adds complexity to the initialization and shut down processes, and consumes additional flash space to store the file. Further, this method increases the delay associated with power down of the underlying processing device. Consequently, rather than solving the problem associated with slower computer performance, the proposed method merely translates the time delay from the power-up to the power down stage.

Another proposed method for decreasing power-up initialization time is to increase the size of the mapped unit. For example, instead of using 512-byte sectors, a system could use 1 KByte, 2 KByte, 4 KByte, or larger sectors. However, the use of larger mapped units increases wasted space due to fragmentation, and reduces performance because of the additional write/erase cycles required for the wasted space.

Still another method employs a multi-level mapping system, such that only the first level map is stored in RAM. This method can reduce power-up time in some implementations because it is not necessary to build the entire mapping table at power-up. Multi-level mapping systems, however, increase complexity and slow operations as the tables must be built and rebuilt at run-time.

Accordingly, it is an object of the invention to provide a faster and more efficient method and system for initializing flash memory devices used in a computer or other processing device.

It is a further object of the invention to reduce the storage space requirements for the mapping table generated at power-up.

### SUMMARY OF INVENTION

The objects of the invention are realized in accordance with the principles of the invention by providing a method and system for reducing the time required for initialization of the flash device at power-up and for minimizing storage requirements when generating the mapping table. The method and system relies in part on the natural tendency of file systems to read and write to storage devices sequentially. The initialization routine as disclosed herein may perform a scan of a given block and may build the mapping table without reading all of the pages in the block. The flash device may also be programmed to employ a special flag in the last page of a block to enable the initialization routine to determine whether the optimization process can be applied to the block, or alternatively, whether deleted sectors are present in that block, thereby requiring the process to read each sector of the block to build the map. Power-up initialization of the flash device is generally completed when the mapping table incorporating physical-to-logical addresses is generated for the set of blocks contained within the flash device.

In one aspect of the present invention, a method of generating mapping table data for a memory block within a non-volatile memory device on power-up of a processing device in which the non-volatile memory device is used, the block comprising a plurality of pages, each page associated with a logical sector number and a consecutive sector count, and the last page of the block further comprising a flag indicating whether deleted pages in the block are present, the method comprising reading the last page of the block; identifying the status of the flag, the logical sector number, and the consecutive sector count of the last page; reading one or more additional pages of the block when the consecutive sector count indicates that not all sectors associated with the block are consecutive; and recording mapping table data for the block without reading all of the pages in the block when the flag indicates that no deleted pages in the block are present.

In another aspect of the present invention, a method of initializing a non-volatile memory device of a processing device in which the non-volatile memory device is used, the non-volatile memory device comprising a plurality of units, each unit comprising a known plurality of sub-units, each sub-unit comprising a logical sub-unit number and a consecutive sub-unit count, the method comprising: reading one of the sub-units of one of the units; reading one or more additional sub-units when the consecutive sub-unit count of the one of the sub-units indicates that not all sub-units associated with the one of the units are consecutive; identifying the logical sub-unit number of the sub-units read; and generating mapping table data for the one of the units without reading all of the sub-units in the unit.

In still another aspect of the invention, computer-readable media embodying a program of instructions executable by a computer program to perform a method of initializing a non-volatile memory device of a processing device in which the non-volatile memory device is used, the non-volatile memory device comprising a plurality of units, each unit comprising a known plurality of sub-units, each sub-unit comprising a logical sub-unit number and a consecutive sub-unit count, the method comprising: reading one of the sub-units of one of the units; reading one or more additional sub-units when the consecutive sub-unit count of the one of the sub-units indicates that not all sub-units associated with the one of the units are consecutive; identifying the logical sub-unit number of the sub-units read; and generating mapping table data for the one of the units without reading all of the sub-units in the unit.

In yet another aspect of the invention, a method of generating mapping table data for a memory block within a non-volatile memory device on power-up of a processing device in which the non-volatile memory device is used, the block comprising a plurality of pages, the method comprising: reading a page of the block; identifying a consecutive sector count associated with the page; and recording mapping table data for the block without reading all of the pages in the block when the consecutive sector count indicates that consecutive sectors are present in the block.

In still another aspect of the invention, a processing device comprising a non-volatile memory device, the memory device comprising a block of pages, the processing device further comprising media embodying a program of instructions executable by the processing device to perform a method of generating mapping table data for a memory block within a non-volatile memory device on power-up of a processing device in which the non-volatile memory device is used, the block comprising a plurality of pages, the method comprising reading a page of the block; identifying a consecutive sector count associated with the page; and recording mapping table data for the block without reading all of the pages in the block when the consecutive sector count indicates that consecutive sectors are present in the block.

Other embodiments of the present invention will become readily apparent to those skilled in the art from the following detailed description, wherein only certain embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is a block diagram of an exemplary processing device using a flash memory.

FIG. 2 is a diagram showing an exemplary file request from the operating system to the flash hardware.

FIG. 3 shows an illustration of a logical-to-physical mapping table in a flash memory device.

FIG. 4 shows a table illustrating how data is stored in exemplary pages of a flash memory device.

FIG. 5 shows a table illustrating how data is stored and the use of the “deleted page(s) present” flag in accordance with an embodiment of the present invention.

FIGS. 6A and 6B show a flowchart of a method for initializing a non-volatile memory device at power-up in accordance with an embodiment of the present invention.

FIG. 7 shows a flow diagram of an illustrative method for generating a mapping table for a plurality of memory blocks in accordance with an embodiment of the present invention.

FIG. 8 shows a flowchart of a method for initializing a flash memory in accordance with an embodiment of the present invention.

### DETAILED DESCRIPTION OF ILLUSTRATIVE EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention.

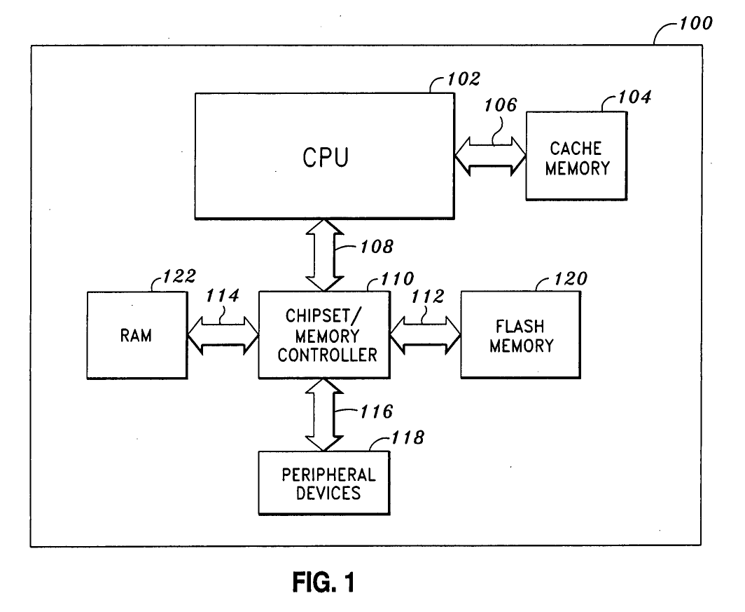

A block diagram of an exemplary computer system 100 using a flash device 120 is shown in FIG. 1A. The system 100 includes CPU 102, cache memory 104, cache-to-processor bus 106 coupling the CPU 102 to cache memory 104, processor bus 108 coupling the CPU 102 to an interface chipset/memory controller 110 (which may include more than one integrated circuit), and a peripheral bus 116 (such as a PCI or AGP bus) coupling the chipset 110 to one or more peripheral devices 118. In addition, memory bus 114 couples the chipset 110 to a random access memory (RAM) 122. In one embodiment, the mapping table in accordance with the present invention is stored in RAM upon power-up of the device. Additional components not shown (such as a BIOS and hard disk drive, optical drive, etc.) may also be present.

The flash initialization routine in accordance with one embodiment may be stored in a separate nonvolatile memory on the device. Alternatively, the flash initialization routine may be stored on a hard drive, BIOS, or other storage device. The file system driver may be loaded into RAM 122 upon power-up. The file system driver may thereafter access the flash device 120 using the initialization routine according to the present invention.

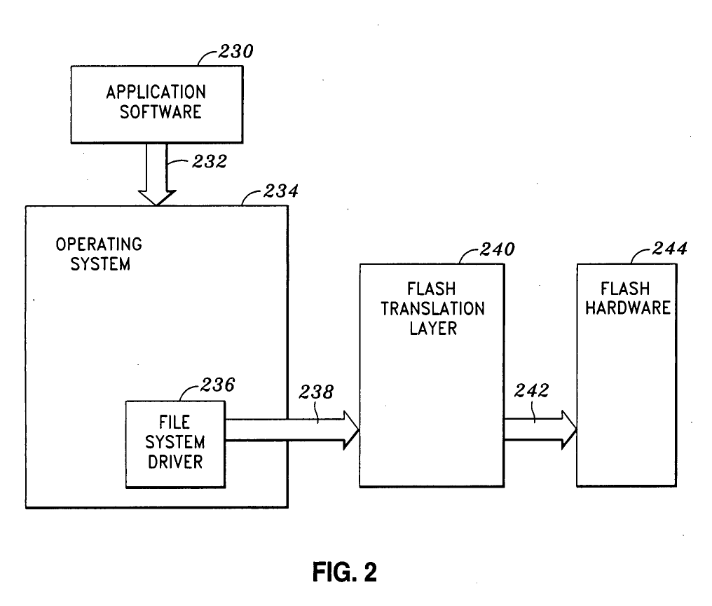

FIG. 2 is a diagram showing an exemplary file request from the operating system to the flash hardware. For the purposes of this disclosure, pages represent physical units on the flash device, while sectors constitute blocks of data requested by the file system driver. In the example shown in FIG. 2, a typical read request is shown. Application software component 230 may issue a function call or other request to the operating system to read data from the file system. Application software component 230 may include many different types of applications, such as music player software, software for digital cameras, and virtually any type of application software used in devices that contain flash memory. In other configurations, no component 230 will be present and the commands are issued from the operating system 234 or another source. In this example, the function call to the operating system 234 is shown conceptually by arrow 232. Thereupon, the operating system 234 transmits the appropriate file request to the file system driver 236, which in turn relays the request to the flash translation layer software 240 as shown by arrow 238. In one configuration, the file system driver 236 issues sector read/write commands to the flash translation layer 240 which include an identification of the logical sector number(s) of the sector(s) to be read or written.

The flash translation layer 240 then issues the request to the flash hardware 244, as shown conceptually by arrow 242. The flash translation layer 240 issues page read/write requests directly to the flash hardware, which requests include the physical address(es) of the page(s) to be written.

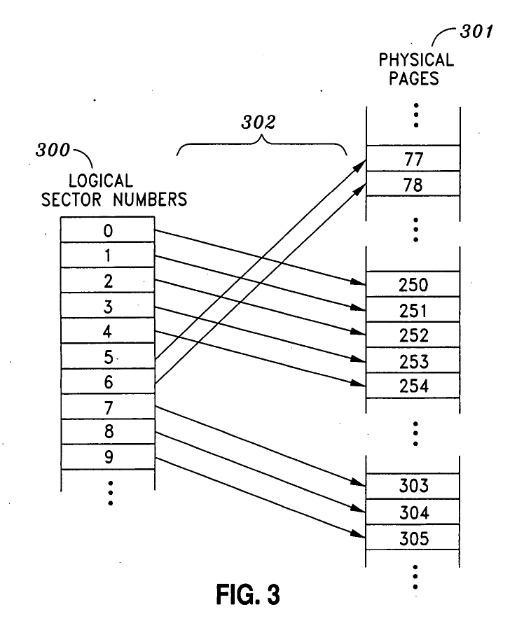

FIG. 3 is a simplified illustration of a logical-to-physical mapping table for a flash memory device, such as the one shown in FIG. 1. The example shown in FIG. 3 is for illustrative purposes only, as different memory devices may contain different mapping methodologies or different numbers and sizes of pages or other units for each sector without departing from the scope of the present invention. Each sector in this configuration constitutes a read/write unit referenced by the file system driver. For clarity, pages here are also assumed to be the same size as sectors and constitute read/write units of the flash device. Pages in this configuration are assumed to be 512 bytes.

Mapping may be applied at the sector level, such that, in one configuration, each logical sector number referenced by the file system driver corresponds to a physical page of the flash device. (Note that in alternative implementations, a sector may be larger than a physical page, and will then correspond to multiple physical pages. In this case, the physical pages corresponding to a particular sector will typically be a block of consecutive pages that is mapped as a single unit, with a single logical sector number. For a given implementation, all sectors will be the same size, and will contain the same number of physical pages.) In FIG. 3, a table 300 of logical sector number entries is shown. While the table 300 explicitly displays 10 logical sector number entries (namely, logical sector numbers 0 through 9), it will be appreciated in this embodiment that the table may include at least 305 logical sector number entries, consistent with the number of physical pages illustrated in corresponding table 301. The illustrated 10 logical sector numbers are consecutively referred to as sector numbers 0 through 9. A corresponding table 301 of physical pages is also shown. These physical pages in table 301, as noted above, correspond in this illustration to physical pages on the flash device. A group of arrows 302 represents the mapping between the set of logical sectors 300 and the corresponding physical pages 301. In the example shown, logical sector numbers 0 through 4 correspond respectively to physical pages 250, 251, 252, 253, and 254. Logical sector numbers 5 and 6 correspond respectively to physical pages 77 and 78. Logical sector numbers 7, 8 and 9 correspond respectively to physical pages 303, 304 and 305.

In one embodiment, the logical sector number of each page is stored in the redundant area of the page. A mapping table for the entire flash device may be stored in RAM. In FIG. 3, the translation layer can index the logical sector number to access a corresponding page for the file system. The mapping table in existing implementations is generally constructed by reading the redundant area of each page.

In one aspect of the present invention, an improved initialization method and apparatus is disclosed. The improved method and apparatus may comprise a routine that takes advantage of the fact that write requests originating from the file system driver typically specify sequential sectors. In particular, if the file system requests a write of data to an arbitrary sector designated x, it is likely that the next write request will be to write data to sector x+1. This observation is based on the principle that most file system drivers (e.g., FAT, NTFS, etc.) are optimized for use with disk drives. When using disk drives, it is more efficient as a general matter to store a file's sector sequentially on the disk to avoid excessive seeks and delays waiting for the disk to spin. Accordingly, all things being equal, the reads and writes to and from the disk will be sequential rather than random or arbitrary.

The present invention takes advantage of this characteristic of file systems. The system and method of power-up initialization of the flash memory device depends on the sequential allocation of physical pages. As the file system driver issues write requests to the flash translation layer, the flash translation layer may allocate pages sequentially within the block. This sequential allocation means that consecutive logical sectors are ordinarily found in consecutive physical pages on the media.

Consecutive Sector Count

FIG. 3 shows a table 400 illustrating how data is stored in a plurality of physical pages in accordance with an embodiment of the present invention. The table 400 includes a plurality of rows 405 representing the first twelve consecutive physical pages designated 0 through 11. The twelve physical pages are mapped to three blocks 406, 407, and 408, with each block including four pages each. Within each physical page is a data area 401 for storing data, and a redundant area 404 for storing other information associated with the page at issue, including, for example, the logical sector # field 402 and the consecutive sectors field 403. Starting with an exemplary write to physical page 0, the corresponding logical sector number is stored in field 402 as 117. The count of consecutive sectors is assumed to be 0 at this location. The next physical page 1 contains logical sector # 118. Because the pages 1 and logical sector #s are consecutive, the count in the consecutive sector field 403 is incremented by one. The next sequential physical page 2, however, is mapped to logical sector 80. Because this mapping is not consecutive with the immediately previous mapping associated with physical page 1, the consecutive sector count in field 403 is reset to 0. The next physical page 3 corresponds to nonconsecutive logical sector # 292, so the consecutive sector count in field 403 is also set to 0. Physical page 4 is the first page of a new block (407), so the consecutive sector count is reset to zero. Physical pages 4 through 7 in block 407 correspond respectively to consecutive logical sector #s 293 through 296. Accordingly, the consecutive sector field is set to 0 through 3, indicating that for each consecutive page and sector, the count in field 403 is incremented by one. Physical page 8 begins block 408, and so the consecutive sector count again resets to zero. Physical page 9 corresponds to nonconsecutive logical sector # 299, so the consecutive sector count in field 403 is reset to zero. Physical pages 10 and 11 correspond respectively to consecutive logical sectors 300 and 301, so the consecutive sector count is incremented by one.

Sectors versus Blocks (or Other Units)

Generally, depending on the implementation, consecutive logical sectors are not allocated onto consecutive physical pages of a flash device on an infinitely large scale. As an illustration, Nand flash devices may be organized into blocks, with each block constituting many pages each. Each block constitutes, in many implementations, the smallest collection of pages that can be erased in a single erase operation. In these devices, physical pages are typically allocated sequentially within a block, but not necessarily between blocks. Stated differently, after the translation layer writes data to a consecutive sequence of pages within a first block (and proceeds to allocate the remaining pages in that block), the file system may write additional data continuing on a second block that is not sequentially adjacent to the first block.

One reason for non-sequential allocation at the block level is the process of “garbage collection.” Garbage collection is a method for moving non-obsolete data from blocks so that those blocks can be erased and the pages containing the obsolete data can be reused. Another possible reason for this non-sequential allocation is “wear leveling.” As noted earlier, wear leveling is the process of allocating or moving data to and from different blocks to prevent any given block from prematurely wearing out or becoming corrupt due to chronic overuse. In these embodiments, both garbage collection and wear leveling tend to randomize the allocation of data at the block (or larger) level. However, whether or not the block data is substantially random, the data within the blocks will still tend to be sequential. In other embodiments, and depending on the specific implementation of the flash memory and/or the file system, units larger than a block may instead be randomized, with blocks and/or smaller units in some instances remaining sequential.

Initializing Sectors on Power-Up

According to the present invention, it is no longer necessary for the translation layer on power-up to automatically read every sector to build the mapping table. Instead, in one embodiment, the flash translation layer reads the redundant area of the last page of a block, and uses the count of the number of preceding sequential pages in that block to fill in the same number of additional entries in the mapping table. This method, which is based on the assumption that the data in the page (if data has been written to the page) was written sequentially, obviates the need for the flash translation layer to scan all but the redundant area of the last sector of the block being addressed. Thus, in the situation where data is allocated sequentially within the entire block, the mapping table can be created for this block by simply reading the redundant area of the last sector. Note that, if at run time a translation layer allocates pages to sequentially increasing addresses, then the mapping table initialization process at an ensuing start-up occurs starting from the highest page in the block, and moving to lower addresses. Accordingly, the initialization routine at power-up reads the logical sector number in the redundant area of the last sector. Knowing the number of sectors in the block (or the number of remaining sectors), the routine can simply fill in the logical sector numbers in the preceding consecutive sectors of the block by reducing, for each previous consecutive sector, the logical unit number by one.

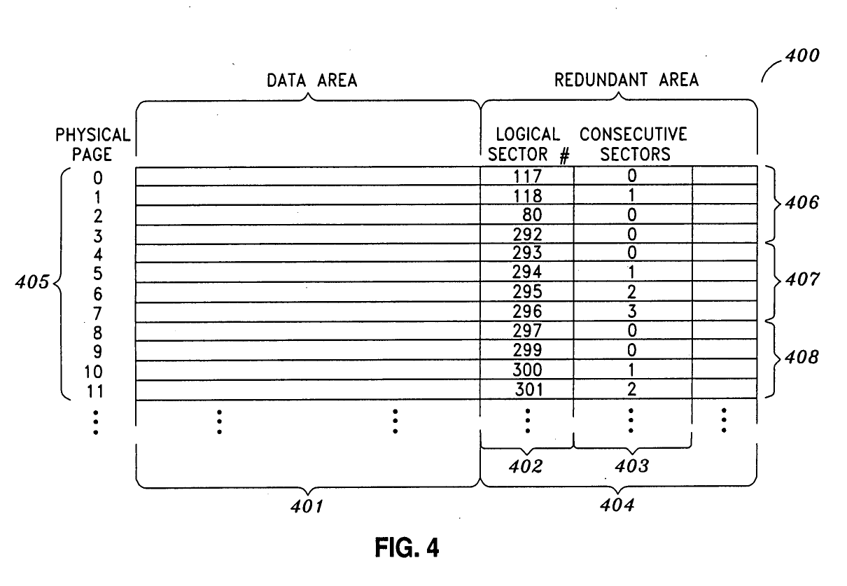

Thus, as an illustration, for initializing block 407 in FIG. 4, the flash translation layer may read the redundant area in page 7 and determine that the four pages associated with block 407 were sequentially mapped as of the last run-time read or write operation. In that case, the flash translation layer need not read any other pages in block 407 in order to initialize block 407.

In other situations, the pages may not be allocated sequentially, requiring that the flash translation layer read additional pages in the block for initialization. For example, in initializing block 408 at startup, the flash translation layer would read the redundant area of page 11 as well as the redundant area at page 8. This is because in block 408, not all pages were sequentially allocated. Nevertheless, even in this instance, initialization time is saved because the flash translation layer does not have to read every page in the block, as is typical of existing solutions.

After initializing a block, such as block 406 in the example of FIG. 4, the flash translation layer may then proceed to the next block (e.g., block 407) to read the redundant area of the next page required for initializing the mapping table. In one embodiment, the next page whose redundant area is read is included in the set of consecutive pages (e.g., the block 407) just beyond the beginning of the page set initialized in the step above (e.g., block 406). Alternatively, the translation layer may proceed to initialize another block (e.g. a nonconsecutive block), depending on criteria like the architecture of the non-volatile memory device.

Because the translation layer no longer need read the redundant area of each and every page of every block at power-up, substantial time savings can be achieved and the initialization routine can be dramatically quicker than in existing implementations. In addition, memory space may be saved in generating the mapping table because, for many blocks, the mapping table can be built using only a single logical sector number and the total number of sectors in the block.

The actual amount of performance improvement that will be achieved depends on, among other factors, the type of data being stored on the flash device. For instance, database files where page updates are permitted may routinely become fragmented (i.e., nonsequential), and consequently the blocks or other units containing these pages may not benefit much. That is, the file system generally must scan each page of these blocks to build a coherent mapping table, in a manner to be explained further below. Conversely, executable or other files that seldom (if ever) change after they are written to flash will likely significantly contribute to an overall faster flash initialization routine at startup.

Deleted Pages

In determining whether or not the translation layer need only scan the last page of sequences of consecutive pages within any given block as noted above, the translation layer can rely on the presence or absence of deleted pages within that block as explained herein. When the data in a logical sector needs to be updated, the file system in some embodiments writes, via the flash translation layer, the updated data to a new physical page and then “flags” the obsolete physical page for deletion by writing one or more bits to a dedicated flag in the redundant area. Some architectures use other methods, such as relying on sequence numbers to keep track of the most current version of the data. In any case, once a page is deleted in the manner described above, that page can no longer be considered a part of a sequential chain of pages.

Ordinarily, the deleted status of any given page may not be detected during the power-up initialization process because the optimization might cause the redundant area for the deleted page to be skipped. Accordingly, in another aspect of the invention, a flag may be maintained in the redundant area of the last page of each block, which flag will be set if any pages in that block are deleted. For convenience and to distinguish this flag from other “deleted” flags associated with each sector in some architectures, this new flag is referred to herein as the “deleted page(s) present” flag. The power-up initialization routine causes the translation layer to read at least the redundant area of the last page of each block. Where the “deleted page(s) present” flag is set, the translation layer determines that it must scan the entire block to build the mapping information for that block. Stated differently, the “deleted page(s) present” flag in the last block may be used to inform the driver that the optimization techniques described herein should not be used for that block.

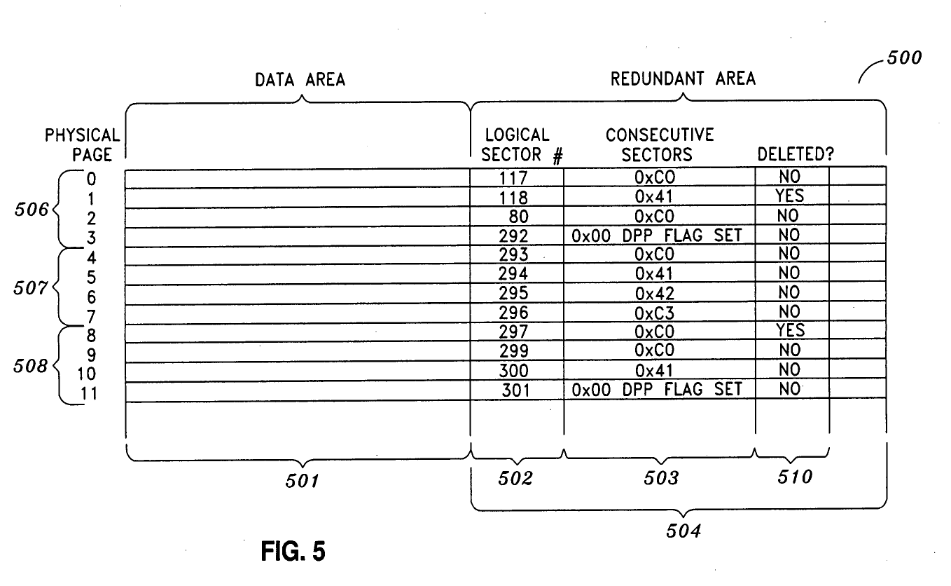

FIG. 5 shows a table illustrating the use of the “deleted page(s) present” flag to determine whether the initialization routine will apply the optimization procedure to a given block. For current technology, typical erase blocks may contain sixteen, thirty-two, or more pages, each. But for clarity in this simplified mapping example, blocks are assumed to include four physical pages each. Similar to the previous table, data area 501 is associated with a plurality of physical pages, of which pages 0 through 11 are explicitly shown. The redundant area 504 contains, for each physical page, the logical sector number field 502, the consecutive sectors field 503, and a deleted flag field 510. The consecutive sectors field 503 constitutes in one embodiment a byte field (represented here in hexadecimal notation), where bits zero through five contain the count, bit six is set if there are no deleted sectors in the block, and bit seven is a parity bit, set to generate even parity. While each page in this configuration has a “deleted” flag, only the last page of the block in one embodiment has a valid “deleted page(s) present” (“DPP”) flag, which is represented in this embodiment as bit six in the consecutive sectors field 503. In block 506, physical page 1 has been marked for deletion as shown by the “yes” flag in field 510. As a result, the “deleted page(s) present” indication will be placed into the last page of block 506, in this case by clearing bit six in field 503 of block 507. The lower six bits are also cleared, as they are no longer needed. On power-up initialization, the flash translation layer reads redundant area of the last page in block 506, determines that a page is deleted in the block, and concludes that the optimization process does not apply and that every page in the block needs to be read.

For block 507, the translation layer reads the redundant area of the last page and maps the physical page 7 to logical sector number 296. Here, the sixth bit is set and thus no deleted pages are present. Accordingly, the optimization process can be used in connection with block 507, and only the last page of the block need be read in order to create the mapping table for that block. For block 508, the translation layer reads the redundant area of physical page 11 and determines that one or more deleted pages are present. As with block 506, the translation layer will then proceed to read each sector in block 508 to build the mapping table on power-up.

While most flash devices limit the number of times that a page can be written without erasing the block, most allow at least two “partial page program” writes to a page. This operation may be necessary to set the “deleted page(s) present” flag, because the last page may have already been programmed with data before the first deletion occurred. In the typical Nand flash architecture (to which the principles of the present invention are not limited), writes can only change “1” bits to “0” bits, and the input data for all other bits that are not to be programmed must be “1's”. Multiple writes to the same page generally increase the chance of an unintentional bit change—i.e., an error—somewhere else in the same block. However, if the architecture is such that the additional write is restricted to changing only a few bits in one byte (such as may be required for setting a deletion flag as discussed above), the chance of an error may be minimized.

In most embodiments, error correction mechanisms may be used to protect the data content of each page from errors. In some embodiments, one or more separate correction mechanisms may be employed to protect parts of the redundant area, so that it is not necessary to read the data area to verify the integrity of the redundant area and build the mapping information. To save space in the redundant area, in some embodiments the “deleted page(s) present” flag is combined with the last sector's count of consecutive sectors by using an invalid sector count to flag the presence of deleted sectors. In this embodiment, the “deleted pages present” flag is set by clearing bit six, and this is done in conjunction with other changes in the byte, which maintain the validity of the parity bit. The lower six bits are no longer needed if the “deleted pages present” flag is set, and so can be cleared to maintain parity. One simple solution is to clear the entire byte, when a deleted page is present. If there is an error, and one bit fails to clear, the parity will be incorrect, and the error will be detected. If the byte is zero, or parity is invalid, then the block may simply default to a manual scan of every sector to build the mapping table in accordance with principles discussed in this disclosure.

Improving Performance for Erased Blocks

In another aspect of the invention, the power-up initialization process may be configured to optimize performance when it encounters erased blocks. In configurations where physical pages are always allocated sequentially, starting from the beginning of a block and never moving to another block until the current allocation block is full, there will generally not be more than one block containing both used pages (which could still contain valid data, or could be flagged for deletion) and erased pages. All other blocks will either be fully erased, or will be full of used (currently in use, or deleted, but not erased) pages. In general, erased pages means that the data within the pages are reprogrammed to their initial state (e.g., all bits are “1's”). Deleted pages, conversely, means that the page has been marked for erasure, but the data to be erased remains in the data field (i.e., the page has not been erased yet). The specific architecture of any given flash memory may be different, but this distinction is made here for the purpose of illustration and clarity in the context of a Nand flash hardware architecture.

Fully used blocks may be detected at power-up by reading the redundant area of the last page of each block, as described above. If, however, the bytes of the redundant area according to one embodiment all contain FF values (using hexadecimal notation), then the bits are set to “1's” and the block is either fully erased or it is the one block from which sectors are currently being allocated. This distinction may be determined by reading the first page of the block. Where both the first sector and the last sector are erased in this embodiment, then the entire block is erased. At this point, there is no need for the file system to read the remaining sectors of the block.

Additional performance enhancements may thereby be achieved for fully erased blocks, because the redundant areas of only the first and last pages of the block need be read. If in this embodiment the last sector is erased and the first sector is not erased, then the block at issue constitutes the single current allocation block. The translation layer must then scan every page of that block to build mapping information on power-up.

In other embodiments, another mechanism, such as a separate non-volatile memory, is configured to store information regarding the current allocation block across power cycles in the flash device. In this instance, it is not necessary to read the first page of potentially fully erased blocks. Any time the last sector is erased in this embodiment, and the block is known to not be the current allocation block (in this case using the separate memory), then the entire block must be erased and the file system can skip the remainder of the sectors in that block on initialization.

Some implementations employ an “erase marker” to verify that blocks have been erased properly. In these implementations, the pages containing the erase markers may be included in the scan at power-up.

Illustrative Power-Up Initialization Methods

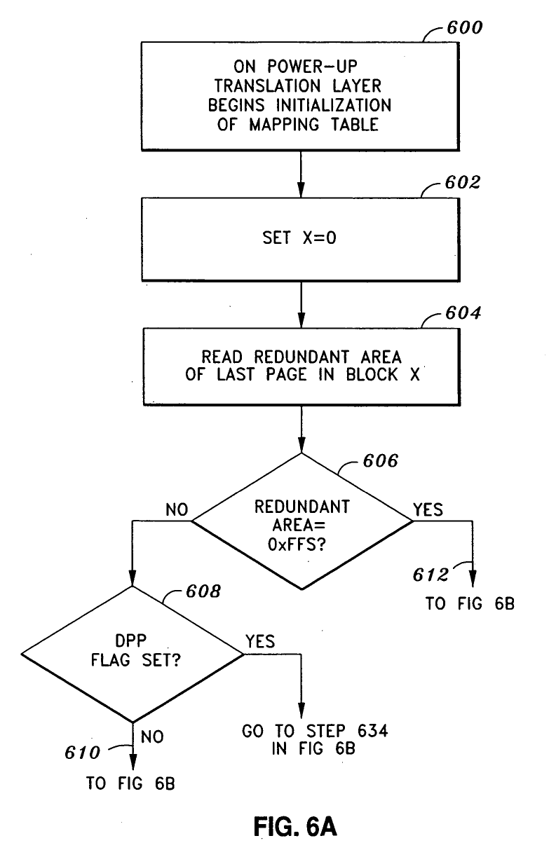

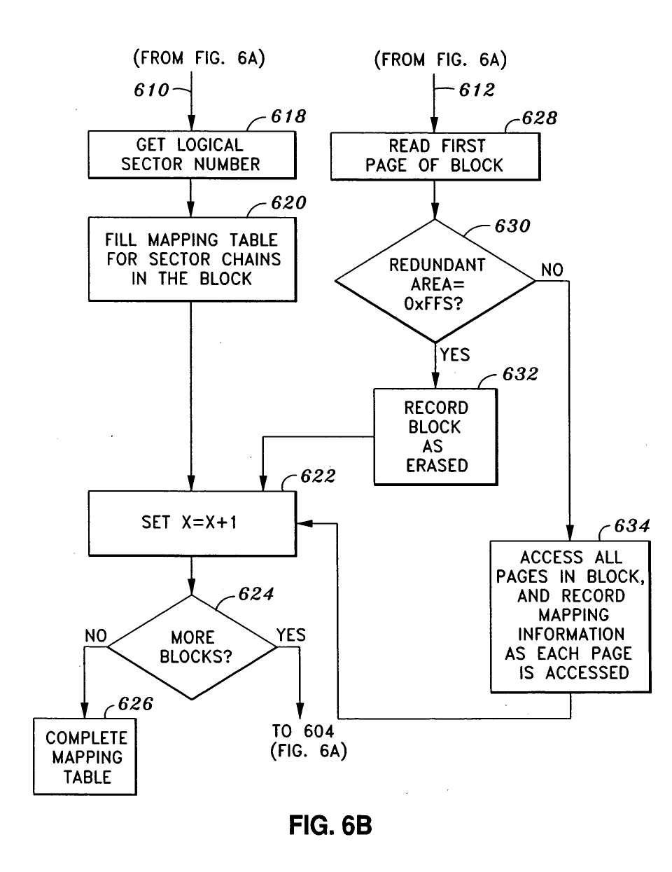

FIGS. 6A and 6B collectively represent a flow diagram of an exemplary method of initializing flash memory and performing the logical-to-physical mapping at start-up in accordance with an embodiment of the present invention. In this embodiment, it is assumed that all bits in blocks that are not programmed (i.e., are erased) are set to “1's.” Accordingly, for a block that is fully erased, every byte in the redundant area of the sectors will be set to FF (hexadecimal). It is also assumed for purposes of this embodiment that a “deleted page(s) present” (“DPP”) flag is available in the last sector of each block. The presence of deleted pages in any given block will cause the DPP flag to be set. Further, it is assumed that the order in which blocks are accessed for the purpose of initialization may vary depending on the implementation. Typically, the blocks are accessed sequentially starting from zero, but this is not a requirement of the present invention.

Referring to FIG. 6A, power-up of the computer or other device is established and the flash translation layer begins the initialization routine to generate the flash mapping table (step 600). The creation of the mapping table begins with the translation layer reading the redundant area of the last page in a block numbered x (step 604). Block x may vary depending on the implementation, and it may be the first block in the flash device, or another block. The ordering of access to blocks may vary without departing from the scope of the present invention. In this example, we set x=0 (step 602) and assume that block “0” is the first block accessed.

In reading the redundant area of the last page within the block, the translation layer first determines whether the redundant area is completely erased (all bytes are FF hexadecimal) (step 606). If yes, then either the entire block is fully erased, or that block constitutes the current allocation block that contains both used and deleted sectors. Referring to FIG. 6B (branch 612), the translation layer proceeds in this embodiment to read the redundant area of the first page of the block (step 628). If the redundant area of that page contains all 0xFFs (step 630), then the translation layer establishes that the block is fully erased. The erased block information may thereupon be stored in a list of free blocks, or a bit-mapped table (having one bit per block) indicating which blocks are free (step 632). This embodiment obviates the need, as noted above, for the file system to scan every sector of a block that is fully erased. Conversely, if the redundant area of the first page does not contain all 0xFFs, then the translation layer in this implementation must access all the pages in the block to build the mapping table (step 634). Note that step 634 handles the special case where a single block contains both used or deleted pages, and erased pages. (The current allocation block is the only block that can have both used or deleted pages, and erased pages.) The mapping table is updated accordingly as each page in the block is accessed. Control then returns to step 622 as the block is incremented and additional blocks are accessed.

Referring back to FIG. 6A, if the last page of the block is not fully erased (step 606), then the translation layer proceeds to check whether the DPP flag is set (step 608). If the DPP flag is set, then the translation layer accesses each page in the block (step 634). The mapping information obtained as a result of step 634 is recorded as each page is accessed. Control then returns to step 622.

In step 622 of FIG. 6B, the block count is incremented by one. The accessing of blocks may not be consecutive in other embodiments. The accessing of blocks may also change over the initialization process, or it may be negative or random. At this point, the initialization routine returns to decision branch 604 and repeats the map-building procedure for block x+1. This process continues until all blocks are accessed and the mapping table is completed (steps 624 and 626).

Note that, in other initialization processes, the decision step 608 may precede the decision step 606 in FIG. 6A. In particular, the file system may first check whether deleted pages are present before ascertaining whether a block is fully erased. Note that the DPP flag is defined such that, if the redundant area is erased, the flag will be interpreted to mean that there are no pages flagged for deletion. The particular implementation may depend, among other things, upon the flash architecture and a determination of which procedure is more efficient for that architecture.

Returning to step 608 of FIG. 6A, if the DPP flag is not set, and the redundant area does not contain all “0xFF's” (as concluded in step 606), then, as shown by arrow 610 in FIG. 6B, the initialization routine records the logical sector number associated with the physical page (step 618). The translation layer then fills in the remaining mapping table entries for the sector chains in that block using the logical sector number of the last sector in each chain and the corresponding count of the number of pages in the chain (step 620). At this point, the mapping information for the block is generated by simply accessing the last sector of the block. Significant time savings can be achieved because the translation layer need not access the remaining pages of the block. Control proceeds to step 622, where the block number is incremented. This procedure is repeated until all blocks have been accessed (steps 624 and 626).

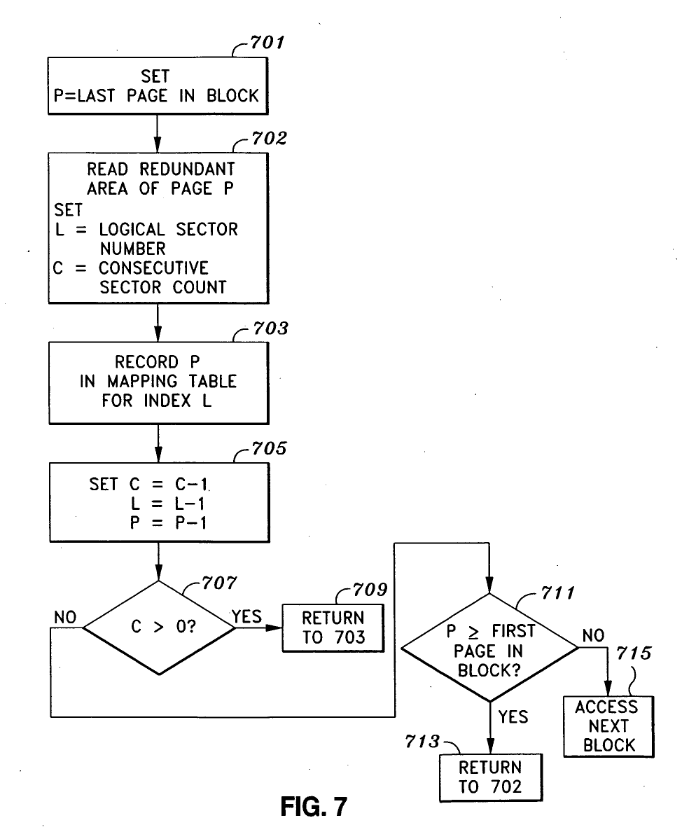

FIG. 7 shows a flow diagram of an illustrative method for generating a mapping table for a plurality of memory blocks in accordance with an embodiment of the present invention. In FIG. 7, a particular block is being accessed by the translation layer for the purpose of building the mapping table at initialization. At step 701, P is set to the last page of that block. At step 702, the redundant area of page P is read. As shown in step 702, L represents the logical sector number associated with the current page, and C represents the count of preceding consecutive sectors. At step 703, the routine records P in the mapping table for the index L. At step 705, C, L, and P are each decremented by 1. If, at step 707, C is greater than zero, control returns to step 703 and the new value of P is recorded for the decremented logical sector number. This process repeats until C is equal to zero, whereupon, at step 711, the routine determines whether P is greater than or equal to the first page in the block. If not, then the mapping table for that block has been initialized and the next applicable block may be accessed for initialization (see step 715). If P is greater than or equal to the first page in the block, control is returned to step 702, where the redundant area associated with the new P value is read and process continues until initialization for that block is complete.

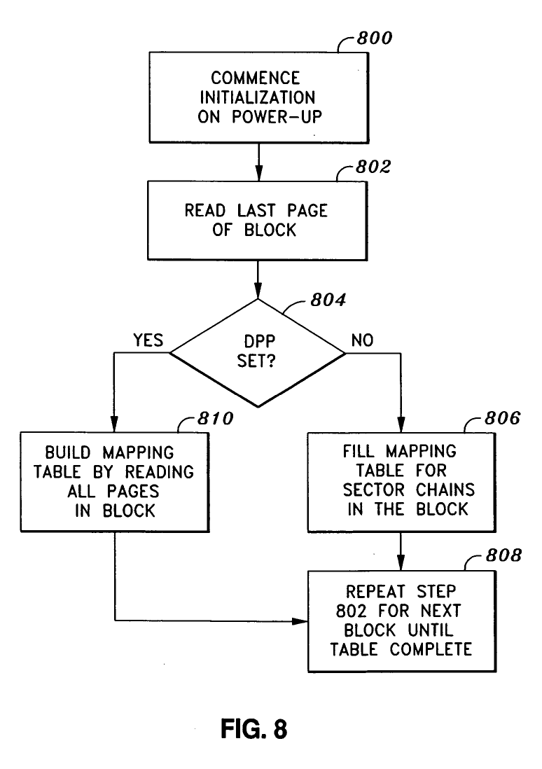

FIG. 8 shows a simplified embodiment of the initialization process in accordance with the present invention. At step 800, the file system commences the mapping initialization process at power-up. The redundant area of the last page of the first block to be accessed is read (step 802). The translation layer determines whether the “deleted page(s) present” flag is set (step 804). If so, the initialization routine builds the mapping table by reading the redundant area of every page in the block (step 810). If not, the optimization technique according to the present invention may be used. Specifically, the initialization routine builds the mapping table for the scanned block by reading the logical sector number, and generating a map of physical to logical addresses by referencing the count of the total number of pages in the block (step 806). After step 810 or 806, the initialization process proceeds by reading the next available block and repeating the process until the mapping table is complete and stored in RAM (step 808).

Alternative Implementations

The implementation described herein assumes for clarity that the mapped units (sectors) are the same size as physical pages of the flash device. As noted above, however, the principles of the present invention are equally applicable to situations where the mapped unit is a multiple of the page size. Similarly, the present implementation assumes for clarity and simplicity that the erase blocks are the same size as the wear-leveling blocks, and that the initialization routine only performs the optimization techniques on chains of consecutive sectors within these blocks. However, the consecutive sector block may be a different size than the erase block. Alternatively, the wear-leveling block may be larger than either the erase block or the consecutive sector block.

Additionally, some “journaling” type systems use a sequence number to avoid the necessity of flagging sectors for deletion. Where multiple physical pages contain the same logical sector number, only the page associated with the highest sequence number is valid. These types of systems can also take advantage of the concept of consecutive sectors. In this case, the presence of a DPP flag is not necessary, because no deleted pages are present (at least none that are flagged in the conventional manner). It nevertheless may be convenient, depending on the configuration, to handle consecutive sectors at the sub-block level only, to allow the file system the freedom to move blocks around as they are erased or for wear-leveling purposes.

Further, the principles of the present invention are not limited to the Nand flash device, and instead can apply to any type of non-volatile memory that has an architecture that allows for sequential reads and/or writes, at least within some unit (e.g., a block). A mapping table may be generated for one or more of the blocks in a memory device, or for all of the blocks.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A method of generating mapping table data for a memory block within a non-volatile memory device on power-up of a processing device in which the non-volatile memory device is used, the block comprising a plurality of pages, each page associated with a logical sector number and a consecutive sector count, and a page of the block further comprising a flag indicating whether deleted pages in the block are present, the method comprising
identifying the status of the flag;
reading the last page of the block and identifying the logical sector number, and the consecutive sector count;
reading one or more additional pages of the block when the consecutive sector count indicates that not all sectors associated with the block are consecutive; and
recording mapping table data for the block without reading all of the pages in the block when the flag indicates that no deleted pages in the block are present.

2. The method of claim 1 wherein the reading, identifying, and recording steps are performed by a flash translation layer associated with the non-volatile device.

3. The method of claim 1 further comprising determining whether the block has been erased by reading the first page of the block.

4. The method of claim 3 wherein the mapping table data is recorded for the block without reading all of the pages in the block when the block has not been erased.

5. The method of claim 1 wherein the mapping table is stored in a random access memory in the processing device.

6. The method of claim 1 wherein the mapping table data for the block is recorded upon reading only the last page in the block.

7. The method of claim 1 wherein the step of reading the one or more additional pages further comprises recording the mapping table data using the logical sector number and the consecutive sector count for one page from each additional chain of consecutive pages.

8. The method of claim 1, wherein the step of recording the mapping table data is performed by a file system driver and a software translation layer.

9. The method of claim 1 wherein the non-volatile memory comprises a flash memory.

10. The method of claim 9 wherein the flash memory comprises a Nand flash memory.

11. A method of initializing a unit of a non-volatile memory device of a processing device in which the non-volatile memory device is used, the non-volatile memory device comprising a plurality of units, each unit comprising a known plurality of sub-units, each sub-unit comprising a logical unit number and a consecutive sub-unit count, the method comprising:
reading one of the sub-units of one of the units;
reading one or more additional sub-units when the consecutive sub-unit count of the one of the sub-units indicates that not all sub-units associated with the one of the units are consecutive;
identifying the logical unit number of the sub-unit; and
generating mapping table data for the one of the units without reading all of the sub-units in the unit.

12. The method of claim 11, wherein the sub-unit of the one of the units comprises the last sub-unit of the unit.

13. The method of claim 11, wherein the non-volatile memory device comprises a flash memory device.

14. The method of claim 13, wherein the flash memory device comprises a Nand flash device.

15. The method of claim 11 wherein the steps of reading, identifying, and generating are performed for each unit of the plurality of units.

16. The method of claim 11 wherein the step of generating mapping table data is performed by a file system associated with the processing device.

17. The method of claim 11 wherein the processing device comprises a computer terminal.

18. The method of claim 17 wherein the mapping table data is stored in a random access memory in the computer terminal.

19. The method of claim 11, wherein the step of generating mapping table data is performed by a file system driver and a software translation layer.

20. The method of claim 11, further comprising a flag in one of the sub-units for indicating whether deleted sub-units in the one of the units are present.

21. A method for optimizing the initialization process for a non-volatile memory device on power-up of a processing device in which the non-volatile memory device is used, the method comprising:
reading a last consecutive page associated with a plurality of sectors comprising a block of a plurality of blocks in the memory device;
determining whether the last consecutive page is erased;
reading the first page of the plurality of pages when the last consecutive page is erased;
determining whether the first page has been erased;
recording that the block has been erased when the first page has been erased; and
repeating the procedure for all other blocks in the memory device.

22. The method of claim 21 wherein the non-volatile memory comprises flash memory.

23. The method of claim 22 wherein the flash memory comprises Nand flash memory.

24. The method of claim 21 wherein no other sector of the plurality of sectors associated with the block is read.

25. Computer-readable media embodying a program of instructions to perform a method of initializing a non-volatile memory device of a processing device in which the non-volatile memory device is used, the non-volatile memory device comprising a plurality of units, each unit comprising a known plurality of sub-units, each sub-unit comprising a logical unit number and a consecutive sub-unit count, the method comprising: reading one of the sub-units of one of the units; reading one or more additional sub-units when the consecutive sub-unit count of the one of the sub-units indicates that not all sub-units associated with the one of the units are consecutive; identifying the logical unit number of the sub-unit; and generating mapping table data for the one of the units without reading all of the sub-units in the unit.

26. A method of generating mapping table data for a memory block within a non-volatile memory device on power-up of a processing device in which the non-volatile memory device is used, the block comprising a plurality of pages, the method comprising:
reading a page of the block;
identifying a consecutive sector count associated with the page; and
recording mapping table data for the block without reading all of the pages in the block when the consecutive sector count indicates that consecutive sectors are present in the block.

27. A processing device comprising a non-volatile memory device, the memory device comprising a block of pages, the processing device further comprising media embodying a program of instructions executable by the processing device to perform a method of generating mapping table data for a memory block within a non-volatile memory device on power-up of a processing device in which the non-volatile memory device is used, the block comprising a plurality of pages, the method comprising reading a page of the block; identifying a consecutive sector count associated with the page; and recording mapping table data for the block without reading all of the pages in the block when the consecutive sector count indicates that consecutive sectors are present in the block.
